(19) United States
(12) Patent Application Publication
(10) Pub. No.: US 2026/0279816 A1
(43) Pub. Date: Sep. 17, 2026

(54) CARBON FILLER DISPERSANT, COMPOSITION CONTAINING CARBON FILLER, AND NONAQUEOUS-ELECTROLYTE SECONDARY BATTERY

(71) Applicant: DIC Corporation, Tokyo (JP)

(72) Inventors: Hiroshi Yoshimura, Ichihara-shi (JP); Yusuke Tajiri, Ichihara-shi (JP); Teppei Ujihara, Ichihara-shi (JP)

(73) Assignee: DIC Corporation, Tokyo (JP)

(21) Appl. No.: 19/168,342

(22) PCT Filed: Apr. 11, 2024
(86) PCT No.: PCT/JP2024/014630

§ 371 Date: Sep. 24, 2025

(30) Foreign Application Priority Data
Apr. 27, 2023 (JP) 2023-073262

(51) Int. Cl. H01M 4/62; H01M 10/052

(52) U.S. Cl. CPC H01M 4/622; H01M 4/625; H01M 10/052

(57) ABSTRACT

Provided is a carbon filler dispersant that improves dispersibility by suppressing aggregation of a carbon filler. Specifically, the carbon filler dispersant is a polyester represented by the following General Formula (1-1), (1-2), or (1-3) (in General Formula (1-1), (1-2), and (1-3), G is an aliphatic diol residue having from 2 to 20 carbons, A is an aromatic dicarboxylic acid residue having from 4 to 18 carbons, X is a monocarboxylic acid residue having from 1 to 20 carbons, Y is a monohydric alcohol residue having from 1 to 30 carbons, and n represents the number of repetitions)

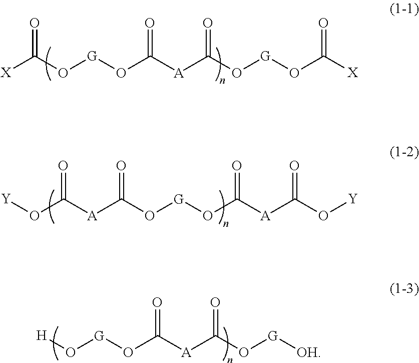

### TECHNICAL FIELD

The present invention relates to a carbon filler dispersant, a carbon filler-containing composition, and a nonaqueous-electrolyte secondary battery.

### BACKGROUND ART

In recent years, introduction of electric vehicles has advanced rapidly in various countries in an effort to reduce carbon dioxide emissions.

Electric vehicles are powered by lithium-ion batteries (LiB), and therefore the performance of the LiB determines the driving distance of the electric vehicles. Additionally, the LiB occupies a large portion of the volume of the electric vehicles. Therefore, a demand exists for higher capacity and smaller size in the LiB.

The LiB is a laminate of a positive electrode sheet, a separator, and a negative electrode sheet, and the positive and negative electrode sheets are each composed of an active material, a conductive material, and a binder resin.

The performance of the LiB is highly dependent on the performance of the active material, and increasing the amount of the active material in the electrodes is an effective measure for increasing the capacity of the LiB. Therefore, a demand exists for a reduction in the usage amounts of the conductive material and the binder resin.

The conductive material plays a role in connecting active material particles and thus, forming conductive paths in the electrode sheets, and in general, a carbon filler such as carbon black or carbon nanotubes is used as the conductive material.

Patent Document 1 discloses a dispersant for enhancing dispersibility of a conductive material, and proposes increasing an amount of an active material by enhancing the dispersibility of the conductive material.

### CITATION LIST

### Patent Document

Patent Document 1: JP 2022-42965 A

### SUMMARY OF INVENTION

### Technical Problem

Since the carbon filler serving as the conductive material has a large specific surface area, the carbon filler is not easily dispersed and is prone to forming coarse aggregates. The dispersant disclosed in Patent Document 1 lowers viscosity of a dispersion containing the carbon filler, and apparently increases the dispersibility. However, coarse aggregates of the carbon filler are observed in the dispersion, and thus the effect of the dispersant cannot be said to be sufficient.

One of the problems to be solved by the present invention is to provide a carbon filler dispersant that improves dispersibility by suppressing aggregation of the carbon filler.

Another problem to be solved by the present invention is to provide a carbon filler-containing composition having improved dispersibility by suppressing aggregation of the carbon filler.

### Solution to Problem

The present inventors conducted intensive studies to solve the above problems, and as a result, discovered that a polyester having a specific structure can suppress aggregation of a carbon filler and enhance dispersibility of the carbon filler, and thus, the present inventors achieved the present invention.

That is, the present invention relates to the following carbon filler dispersant and the like.
1. A carbon filler dispersant that is a polyester represented by General Formula (1-1), (1-2), or (1-3).

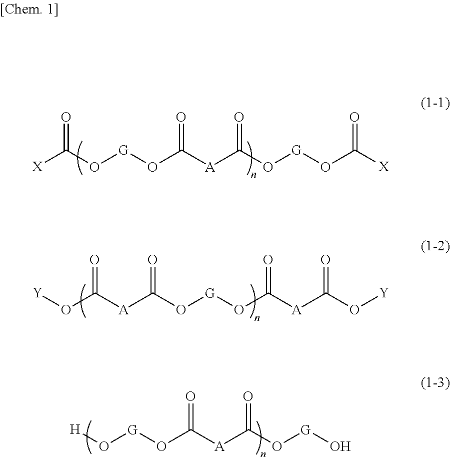

(In General Formulae (1-1), (1-2), and (1-3),
G is an aliphatic diol residue having from 2 to 20 carbons,
A is an aromatic dicarboxylic acid residue having from 4 to 18 carbons,
X is a monocarboxylic acid residue having from 1 to 20 carbons,
Y is a monohydric alcohol residue having from 1 to 30 carbons, and
n represents the number of repetitions.)
2. The carbon filler dispersant according to 1, wherein A includes one or more selected from a phthalic acid residue, an isophthalic acid residue, a terephthalic acid residue, and a naphthalenedicarboxylic acid residue.
3. The carbon filler dispersant according to 1 or 2, wherein G is an aliphatic diol residue having a branched structure having 3 to 20 carbons.
4. The carbon filler dispersant according to any one of 1 to 3, wherein the polyester is an amorphous polyester.
5. The carbon filler dispersant according to any one of 1 to 4, wherein the polyester has a number-average molecular weight in a range from 400 to 10000.
6. The carbon filler dispersant according to any one of 1 to 5, wherein the carbon filler is one or more selected from graphite, carbon black, carbon nanotubes, graphene, and graphene oxide.
7. A carbon filler dispersion containing a carbon filler, the carbon filler dispersant described in any one of 1 to 6, and a dispersion medium.
8. The carbon filler dispersion according to 7, wherein the carbon filler is one or more selected from graphite, carbon black, carbon nanotubes, graphene, and graphene oxide.
9. An electrode for a lithium secondary battery, the electrode including a carbon filler, the carbon filler dispersant described in any one of 1 to 6, and an electrode active material.
10. A lithium secondary battery containing the electrode for a lithium secondary battery described in 9.

### Advantageous Effects of Invention

According to the present invention, a carbon filler dispersant that improves dispersibility of a carbon filler can be provided.

According to the present invention, a carbon filler-containing composition having improved dispersibility of the carbon filler can be provided.

### DESCRIPTION OF EMBODIMENTS

Hereinafter, an embodiment of the present invention will be described. The present invention is not limited by the following embodiment, and modifications can be appropriately applied in a range that does not impair the effect of the present invention.

Compounds in the present specification may be derived from fossil resources or from biological resources.

### Carbon Filler Dispersant

A carbon filler dispersant of the present invention is a polyester represented by the following General Formula (1-1), (1-2), or (1-3). Hereinafter, the polyester serving as the carbon filler dispersant of the present invention may be referred to as “the polyester of the present invention”.

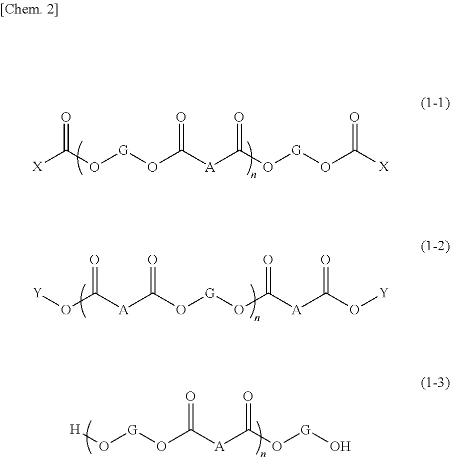

### (In General Formulae (1-1), (1-2), and (1-3),

G is an aliphatic diol residue having from 2 to 20 carbons,
A is an aromatic dicarboxylic acid residue having from 4 to 18 carbons,
X is a monocarboxylic acid residue having from 1 to 20 carbons,
Y is a monohydric alcohol residue having from 1 to 30 carbons, and
n represents the number of repetitions.)

It is presumed that in the polyester of the present invention, the aromatic dicarboxylic acid residue moiety has an increased affinity for the carbon filler due to the π-π interaction, and thus, the polyester of the present invention can be adsorbed on the carbon filler. It is also considered that the polyester of the present invention adsorbed on the carbon filler can suppress aggregation of the carbon filler and disperse the carbon filler due to the portion of the polyester other than the aromatic dicarboxylic acid residue being miscible with a matrix resin.

In the present invention, the terms “diol residue” and “alcohol residue” refer to organic groups remaining after removing the hydroxyl groups from the diol and the alcohol, respectively.

In the present invention, the term “carboxylic acid residue” refers to an organic group remaining after removing a carboxyl group from the carboxylic acid. The number of carbons in the carboxylic acid residue does not include the number of carbons in the carboxyl group.

The aliphatic chain of the aliphatic diol residue G having from 2 to 20 carbons may be linear or branched, and may include an alicyclic structure and/or an ether bond. Moreover, the aliphatic chain of the aliphatic diol residue G may be a saturated aliphatic chain or an unsaturated aliphatic chain having a carbon-carbon unsaturated bond.

The aliphatic diol residue G having from 2 to 20 carbons is preferably an aliphatic diol residue having a branched structure having 3 to 20 carbons, and is more preferably a diol represented by the following General Formula (G-1).

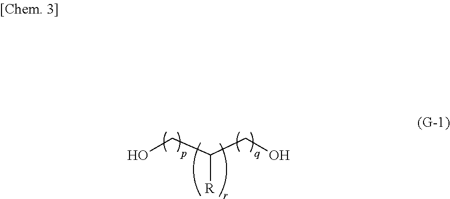

(In General Formula (G-1),
p is an integer of 1 or greater, q is an integer of 0 or greater, and r is an integer of 1 or greater,
R is a hydrogen atom or an alkyl group having 1 or more carbons, and at least one of r Rs is an alkyl group having 1 or more carbons, and
the sum of p, q, r and the number of carbons of R is an integer from 3 to 20.)

Examples of the aliphatic diol residue G having from 2 to 20 carbons include an ethylene glycol residue, a 1,2-propylene glycol residue, a 1,3-propanediol residue, a 1,2-butanediol residue, a 1,3-butanediol residue, a 2-methyl-1,3-propanediol residue, a 1,4-butanediol residue, a 1,5-pentanediol residue, a 2,2-dimethyl-1,3-propanediol (neopentyl glycol) residue, a 2,2-diethyl-1,3-propanediol (3,3-dimethylolpentane) residue, a 2-n-butyl-2-ethyl-1,3-propanediol (3,3-dimethylolheptane) residue, a 3-methyl-1,5-pentanediol residue, a 1,6-hexanediol residue, a 2,2,4-trimethyl-1,3-pentanediol residue, a 2-ethyl-1,3-hexanediol residue, a 2-methyl-1,8-octanediol residue, a 1,9-nonanediol residue, a 1,10-decanediol residue, a 1,12-dodecanediol residue, a 1,2-tetradecanediol residue, and a 1,2-dodecanediol residue.

The aliphatic diol residue G having from 2 to 20 carbons may contain an alicyclic structure, and examples of the aliphatic diol residue having from 2 to 20 carbons and containing such an alicyclic structure include a 1,3-cyclopentanediol residue, a 1,2-cyclohexanediol residue, a 1,3-cyclohexanediol residue, a 1,4-cyclohexanediol residue, a 1,2-cyclohexanedimethanol residue, and a 1,4-cyclohexanedimethanol residue.

The aliphatic diol residue G having from 2 to 20 carbons may contain an ether bond (—O—), and examples of the aliphatic diol residue having from 2 to 20 carbons and containing such an ether bond include a diethylene glycol residue, a triethylene glycol residue, a tetraethylene glycol residue, a dipropylene glycol residue, and a tripropylene glycol residue.

G is preferably an aliphatic diol residue having from 2 to 14 carbons, more preferably an ethylene glycol residue, a diethylene glycol residue, a 1,2-propylene glycol residue, a 1,6-hexanediol residue, a 3-methyl-1,5-pentanediol residue, a 1,4-butanediol residue, a 1,3-butanediol residue, a 1,2-tetradecanediol residue, or a 1,2-dodecanediol residue.

The aromatic dicarboxylic acid residue A having from 4 to 18 carbons is a residue of a dicarboxylic acid with two carboxyl groups substituted on an aromatic ring, and the aromatic ring may be further substituted with a substituent (for example, an alkyl group having from 1 to 6 carbons).

Examples of the aromatic dicarboxylic acid residue A having from 4 to 18 carbons include 2,5-furandicarboxylic acid, a phthalic acid residue, an isophthalic acid residue, a terephthalic acid residue, a 1,4-naphthalenedicarboxylic acid residue, a 1,5-naphthalenedicarboxylic acid residue, a 2,3-naphthalenedicarboxylic acid residue, a 2,6-naphthalenedicarboxylic acid residue, 4,4′-biphenyldicarboxylic acid, 1,5-anthracenedicarboxylic acid, a 2,3-anthracenedicarboxylic acid residue, and 9,10-anthracenedicarboxylic acid.

In the present specification, the term “aromatic dicarboxylic acid residue” includes an aromatic dicarboxylic acid residue in which the aromatic ring is further substituted with a substituent (for example, an alkyl group having from 1 to 6 carbons), and for example, the term “terephthalic acid residue” includes a dimethyl terephthalate residue, and the term “2,6-naphthalenedicarboxylic acid residue” includes a dimethyl 2,6-naphthalenedicarboxylate residue.

The aromatic dicarboxylic acid residue A having from 6 to 18 carbons preferably includes one or more selected from a phthalic acid residue, an isophthalic acid residue, a terephthalic acid residue, and a naphthalenedicarboxylic acid residue. The phthalic acid residue, the isophthalic acid residue, the terephthalic acid residue, and the naphthalenedicarboxylic acid residue all have high affinity for the carbon filler, and thus can be expected to have high dispersing effect.

The monocarboxylic acid residue X having from 1 to 20 carbons may be, for example, an aliphatic monocarboxylic acid residue having from 1 to 20 carbons or an aromatic monocarboxylic acid residue having from 1 to 20 carbons, but is preferably the aliphatic monocarboxylic acid residue having from 1 to 20 carbons.

When X is the aliphatic monocarboxylic acid residue having from 1 to 20 carbons, the aliphatic chain of the aliphatic monocarboxylic acid residue having from 1 to 20 carbons may be linear or branched, and may include an alicyclic structure and/or an ether bond. The aliphatic chain of the aliphatic monocarboxylic acid residue having from 1 to 20 carbons may be a saturated aliphatic chain, or may be an unsaturated aliphatic chain having a carbon-carbon unsaturated bond.

Examples of the monocarboxylic acid residue X having from 1 to 20 carbons include an acetic acid residue, a propionic acid residue, a butanoic acid residue, a hexanoic acid residue, an octanoic acid residue, an octylic acid residue, a benzoic acid residue, a dimethylbenzoic acid residue, a trimethylbenzoic acid residue, a tetramethylbenzoic acid residue, an ethylbenzoic acid residue, a propylbenzoic acid residue, a butylbenzoic acid residue, a cumic acid residue, a para-tert-butylbenzoic acid residue, an ortho-toluic acid residue, a meta-toluic acid residue, a para-toluic acid residue, an ethoxybenzoic acid residue, a propoxybenzoic acid residue, and an anisic acid residue.

The monohydric alcohol residue Y having from 1 to 30 carbons may be, for example, any of an aliphatic monohydric alcohol residue having from 1 to 30 carbons and an aromatic monohydric alcohol residue having from 6 to 30 carbons, and is preferably the aliphatic monohydric alcohol residue having from 1 to 30 carbons.

When Y is the aliphatic monohydric alcohol residue having from 1 to 30 carbons, the aliphatic chain of the aliphatic monohydric alcohol residue having from 1 to 30 carbons may be linear or branched, and may contain an alicyclic structure and/or an ether bond. The aliphatic chain of the aliphatic monohydric alcohol residue having from 1 to 30 carbons may be a saturated aliphatic chain, or may be an unsaturated aliphatic chain having a carbon-carbon unsaturated bond.

The monohydric alcohol residue Y having from 1 to 30 carbons is preferably an alkyl alcohol residue having from 1 to 10 carbons or an alcohol residue of a polyalkylene glycol monoalkyl ether having from 5 to 30 carbons.

Examples of Y as the alkyl alcohol residue having from 1 to 10 carbons include a methanol residue, an ethanol residue, a propanol residue, a butanol residue, a pentanol residue, a hexanol residue, a cyclohexanol residue, a heptanol residue, an octanol residue, a nonanol residue, and a decanol residue.

Examples of Y as an alcohol residue of a polyalkylene glycol alkyl ether having from 5 to 30 carbons include alcohol residues of polyethylene glycol alkyl ethers such as diethylene glycol monomethyl ether and triethylene glycol monomethyl ether; polypropylene glycol alkyl ethers such as polypropylene glycol monomethyl ether and polypropylene glycol monoethyl ether; and (polyethylene glycol/polypropylene glycol) monoalkyl ethers and the like.

The average of the number of repetitions n is preferably in a range from 0.1 to 20, more preferably in a range from 0.2 to 15, and even more preferably in a range from 0.5 to 10.

The average of the number of repetitions n can be calculated from the number-average molecular weight of the polyester of the present invention.

The lower limit of the number-average molecular weight (Mn) of the polyester of the present invention is, for example, 300 or greater, 400 or greater, or 450 or greater, and the upper limit thereof is, for example, 20000 or less, 10000 or less, 8000 or less, 5000 or less, or 3000 or less.

The number-average molecular weight (Mn) of the polyester of the present invention is, for example, in a range from 300 to 20000, preferably in a range from 400 to 10000, and more preferably in a range from 450 to 8000.

The above number-average molecular weight (Mn) is a value in terms of calibration with a polystyrene standard based on gel permeation chromatography (GPC) measurements, and is measured in accordance with the method described in Examples.

The acid value of the polyester of the present invention has a lower limit of, for example, 0.001 mgKOH/g or greater, 0.01 mgKOH/g or greater, 0.1 mgKOH/g or greater, or 1 mgKOH/g or greater, and an upper limit of, for example, 10 mgKOH/g or less, 5 mgKOH/g or less, 3 mgKOH/g or less, or 1 mgKOH/g or less.

The acid value of the polyester of the present invention is, for example, in a range from 0.001 to 3 mgKOH/g.
The acid value of the polyester is confirmed by a method described in Examples.

The hydroxyl value of the polyester of the present invention is, for example, in a range of from 0.1 to 400 mgKOH/g, preferably in a range of from 0.1 to 200 mgKOH/g, and more preferably in a range of from 0.1 to 100 KOH/g. The hydroxyl value of the polyester is confirmed by a method described in Examples.

The polyester of the present invention is preferably an amorphous polyester. The term “amorphous” as used herein means that the polyester does not exhibit a distinct endothermic peak in differential scanning calorimetry (DSC). Specifically, a polyester that does not exhibit a distinct endothermic peak when subjected to the differential scanning calorimetry as described in Examples is the amorphous polyester.

When the polyester is amorphous, the polyester is easily dissolved in the matrix resin and a solvent, and can be uniformly adsorbed on the surface of the carbon filler, and thus, the dispersibility can be enhanced.

The polyester of the present invention may be any polyester satisfying General Formula (1-1), (1-2), or (1-3), and a mixture of two or more of the polyesters having different structures from each other, may be used as the polyester of the present invention.

The polyester of the present invention is obtained by using reaction raw materials including an aliphatic diol, an aromatic dicarboxylic acid, and a monohydric alcohol and/or a monocarboxylic acid (however, a monohydric alcohol and/or a monocarboxylic acid is not required for the production of the polyester represented by General Formula (1-3); and the monohydric alcohol and/or the monocarboxylic acid is an optional component). The term “reaction raw materials” as used herein means raw materials constituting the polyester of the present invention, and does not include a solvent or catalyst that does not constitute the polyester.

The method for producing the polyester of the present invention is not particularly limited, and the polyester can be produced by a known method, or can be produced by a production method described below.

The reaction raw materials of the polyester of the present invention need only include an aliphatic diol, an aromatic dicarboxylic acid, and a monohydric alcohol and/or a monocarboxylic acid, but may contain another raw material as well.

Of the total amount of the reaction raw materials of the polyester of the present invention, preferably 90 mass % or more consists of an aliphatic diol, an aromatic dicarboxylic acid, and a monohydric alcohol and/or a monocarboxylic acid, and more preferably the reaction raw materials include only an aliphatic diol, an aromatic dicarboxylic acid, and a monohydric alcohol and/or a monocarboxylic acid.

The aliphatic diol used in the production of the polyester of the present invention is an aliphatic diol corresponding to the aliphatic diol residue G having from 2 to 20 carbons, and a single type of the aliphatic diol to be used may be used alone, or two or more types of the aliphatic diol may be used in combination.

The aromatic dicarboxylic acid used in the production of the polyester of the present invention is an aromatic dicarboxylic acid corresponding to the aromatic dicarboxylic acid residue A having from 6 to 18 carbons, and a single type of the aromatic dicarboxylic acid to be used may be used alone, or two or more types of the aromatic dicarboxylic acid may be used in combination.
The monocarboxylic acid used in the production of the polyester of the present invention is a monocarboxylic acid corresponding to the monocarboxylic acid residue X having from 1 to 20 carbons, and a single type of the monocarboxylic acid to be used may be used alone, or two or more types of the monocarboxylic acid may be used in combination.
The monohydric alcohol used in the production of the polyester of the present invention is a monohydric alcohol corresponding to the monohydric alcohol residue Y having from 1 to 30 carbons, and a single type of the monohydric alcohol to be used may be used alone, or two or more types of the monohydric alcohol may be used in combination.

As the monocarboxylic acid used in the production of the polyester of the present invention, a hydrogenated vegetable oil fatty acid may be used. Examples of the hydrogenated vegetable oil fatty acid include hydrogenated coconut oil fatty acid, hydrogenated palm kernel oil fatty acid, hydrogenated palm oil fatty acid, hydrogenated olive oil fatty acid, hydrogenated castor oil fatty acid, and hydrogenated rapeseed oil fatty acid. These are obtained by hydrolyzing and hydrogenating oil-based agents obtained from coconuts, palm kernels, palms, olives, castor beans, and rapeseeds, respectively, and are all mixtures of two or more long-chain aliphatic monocarboxylic acids including an aliphatic monocarboxylic acid having from 8 to 21 carbons.

As the monocarboxylic acid used for the production of the polyester of the present invention, the above-mentioned vegetable oil fatty acids that have not been hydrogenated may be used within a range that does not impair the effects of the present invention. Moreover, the vegetable oil fatty acid is not limited to the above.

When the polyester of the present invention is a polyester obtained by using an aliphatic diol, an aromatic dicarboxylic acid, and a hydrogenated vegetable oil fatty acid as reaction raw materials, the obtained polyester is obtained as a mixture of two or more types of polyester represented by General Formula (1-1).

The aliphatic diol, the aromatic dicarboxylic acid, the monohydric alcohol, and the monocarboxylic acid used in the production of the polyester of the present invention can all be used in the form of derivatives thereof, respectively. Examples of the derivatives include esterified products, acid chlorides, acid anhydrides, and cyclic esters.

For example, since an epoxy compound undergoes ring-opening to form a diol when reacted with a carboxylic acid, an aliphatic epoxy compound may be used as a derivative of the aliphatic diol that is used as a reaction raw material of the present invention.

The polyester represented by General Formula (1-1) can be produced, for example, by charging and reacting all at once an aliphatic diol, an aromatic dicarboxylic acid, and a monocarboxylic acid at amounts at which the equivalent of carboxyl groups is greater than the equivalent of hydroxyl groups. Moreover, the polyester represented by General Formula (1-1) can also be produced by, for example, reacting an aliphatic diol and an aromatic dicarboxylic acid at any equivalent ratio, and then reacting the terminal hydroxyl group of the obtained polyester with a monocarboxylic acid to cap the hydroxyl group with a carboxylic acid residue.

The polyester represented by General Formula (1-2) can be produced, for example, by charging and reacting all at once an aliphatic diol, an aromatic dicarboxylic acid, and a monohydric alcohol at amounts at which the equivalent of carboxyl groups is greater than the equivalent of hydroxyl groups. Moreover, the polyester represented by General Formula (1-2) can also be produced, for example, by reacting an aliphatic diol and an aromatic dicarboxylic acid at any equivalent ratio, and then reacting the terminal of the obtained polyester with a monohydric alcohol.

The polyester represented by General Formula (1-3) can be produced by, for example, charging and reacting all at once an aliphatic diol and an aromatic dicarboxylic acid at amounts at which the equivalent of hydroxyl groups is greater than the equivalent of carboxyl groups. Moreover, the polyester represented by General Formula (1-3) can also be produced by, for example, reacting an aliphatic diol and an aromatic dicarboxylic acid at any equivalent ratio, and then reacting the terminal of the obtained polyester with an aliphatic diol.

In the production of the polyester of the present invention, the reaction of the reaction raw materials may be carried out by an esterification reaction at a temperature in a range of, for example, from 170 to 250° C. for a time in a range of from 10 to 25 hours, in the presence of an esterification catalyst as necessary.

The conditions such as the temperature and time of the esterification reaction are not particularly limited and may be appropriately set.

Examples of the esterification catalyst include titanium-based catalysts such as tetra-isopropyl titanate and tetrabutyl titanate; zinc-based catalysts such as zinc acetate; tin-based catalysts such as tin octylate and dibutyltin oxide; and organic sulfonic acid-based catalysts such as p-toluenesulfonic acid.

The usage amount of the esterification catalyst may be appropriately set, but is usually in a range from 0.0001 to 0.1 parts by mass per 100 parts by mass of the total amount of the reaction raw materials.

### Carbon Filler Dispersion

The carbon filler dispersion of the present invention contains a carbon filler, the carbon filler dispersant of the present invention, and a dispersion medium. An electrode-forming composition described later is usually prepared by adding various components to the carbon filler dispersion.

Hereinafter, each component contained in the carbon filler dispersion of the present invention will be described.

### Carbon Filler

The carbon filler contained in the carbon filler dispersion of the present invention is not particularly limited, and examples thereof include graphite, carbon black (such as acetylene black, furnace black, hollow carbon black, channel black, thermal black, and Ketjenblack), carbon nanotubes (such as single-walled carbon nanotubes and multi-walled carbon nanotubes), graphene, and graphene oxide.
A single type of the carbon filler may be used alone, or two or more types of the carbon filler may be used in combination.

The shape of the carbon filler, such as the particle size, fiber length, and fiber diameter, is not particularly limited, and may be appropriately adjusted depending on the intended use. For example, the carbon nanotubes include single-walled carbon nanotubes in which a single sheet of graphite is wound as one layer and multi-walled carbon nanotubes in which graphite is wound into two or more layers, and any of these types of carbon nanotubes can be used.

In addition, the surface treatment state of the carbon filler is not particularly limited, and the surface may be modified with, for example, a saturated fatty acid or the like depending on the intended use.

The content of the carbon filler is not particularly limited, but with respect to the total amount of the dispersion, the content of the carbon filler is preferably in a range from 0.01 to 15.0 mass %, more preferably in a range from 0.1 to 10.0 mass %, even more preferably in a range from 0.2 to 8.0 mass %, particularly preferably in a range from 1.0 to 6.0 mass %, or highly preferably in a range from 2.0 to 5.0 mass %.

The content of the carbon filler dispersant of the present invention is not particularly limited, but per 100 parts by mass of the carbon filler, the content of the carbon filler dispersant is, for example, in a range from 0.01 to 50 parts by mass, preferably in a range from 0.1 to 40 parts by mass, and more preferably in a range from 1 to 30 parts by mass.

### Dispersion Medium

The dispersion medium contained in the carbon filler dispersion of the present invention is not particularly limited as long as the carbon filler can be dispersed in the dispersion medium, and there can be used an organic solvent such as an aromatic solvent, an alcohol solvent, a polyhydric alcohol solvent, a glycol ether solvent, an ester solvent, an amine/amide-based solvent, a heterocyclic ring-based solvents, and a sulfone-based solvent; and water (purified water, distilled water, pure water, ultrapure water, and the like).

Examples of the aromatic solvent include benzyl alcohol, ethylene glycol monophenyl ether, ethylene glycol monobenzyl ether, propylene glycol monophenyl ether, diethylene glycol monophenyl ether, ethylene glycol monophenyl ether, propylene glycol monophenyl ether, phenyl alkylsulfonates, butyl phthalate, ethylhexyl phthalate, tridecyl phthalate, ethylhexyl trimellitate, diethylene glycol dibenzoate, and dipropylene glycol dibenzoate.

Examples of the alcohol solvent include ethanol, n-propanol, isopropanol, n-butanol, isobutanol, tert-butyl alcohol, 1-pentanol, isoamyl alcohol, sec-amyl alcohol, 3-pentanol, tert-amyl alcohol, n-hexanol, methylamyl alcohol, 2-ethylbutanol, n-heptanol, 2-heptanol, 3-heptanol, n-octanol, 2-octanol, 2-ethylhexanol, 3,5,5-trimethylhexanol, nonanol, n-decanol, undecanol, n-decanol, trimethylnonyl alcohol, tetradecanol, heptadecanol, cyclohexanol, and 2-methylcyclohexanol.

Examples of the polyhydric alcohol solvent include ethylene glycol, diethylene glycol, triethylene glycol, polyethylene glycol, propylene glycol, dipropylene glycol, polypropylene glycol, butylene glycol, hexanediol, pentanediol, glycerin, hexanetriol, thiodiglycol, 3-methyl-1,3-butanediol, triethylene glycol, dipropylene glycol, 1,3-propanediol, 1,3-butanediol, 1,5-pentanediol, hexylene glycol, and octylene glycol.

Examples of the glycol ether solvent include methyl isopropyl ether, ethyl ether, ethyl propyl ether, ethyl butyl ether, isopropyl ether, butyl ether, hexyl ether, 2-ethyl hexyl ether, ethylene glycol monohexyl ether, ethylene glycol mono-2-ethyl butyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monobutyl ether, tetraethylene glycol monobutyl ether, 3-methyl-3-methoxy-1-butanol, 3-methoxy-1-butanol, propylene glycol monomethyl ether, propylene glycol monoethyl ether, propylene glycol monopropyl ether, propylene glycol monobutyl ether, propylene glycol tert-butyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, tetrapropylene glycol monobutyl ether, ethylene glycol monomethyl ether acetate, triethylene glycol monomethyl ether, triethylene glycol monoethyl ether, and triethylene glycol monobutyl ether.

Examples of the ester solvent include propylene glycol methyl ether acetate, propylene glycol diacetate, 3-methyl-3-methoxybutyl acetate, propylene glycol ethyl ether acetate, ethylene glycol ethyl ether acetate, butyl formate, isobutyl formate, isoamyl formate, propyl acetate, butyl acetate, isopropyl acetate, isobutyl acetate, isoamyl acetate, methyl propionate, ethyl propionate, propyl propionate, isobutyl propionate, isoamyl propionate, methyl butyrate, ethyl butyrate, propyl butyrate, butyl butyrate, methyl isobutyrate, ethyl isobutyrate, propyl isobutyrate, methyl valerate, ethyl valerate, propyl valerate, methyl isovalerate, ethyl isovalerate, propyl isovalerate, methyl trimethylacetate, ethyl trimethylacetate, propyl trimethylacetate, methyl caproate, ethyl caproate, propyl caproate, methyl caprylate, ethyl caprylate, propyl caprylate, methyl laurate, ethyl laurate, methyl oleate, ethyl oleate, caprylic acid triglycerides, acetyl tributyl citrate, octyl oxystearate, propylene glycol monoricinoleate, methyl 2-hydroxyisobutyrate, and 3-methoxybutyl acetate.

Examples of the amine/amide-based solvent include amine-based solvents such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine; and N-methyl-2-pyrrolidone (NMP), N-ethyl-2-pyrrolidone (NEP), N,N-dimethylformamide, N,N-dimethylacetamide, N,N-diethylacetamide, and N-methylcaprolactam.

Examples of the heterocyclic ring-based solvent include cyclohexylpyrrolidone, 2-oxazolidone, 1,3-dimethyl-2-imidazolidinone, and γ-butyrolactone.
Examples of the sulfone-based solvent include dimethyl sulfoxide, hexamethylphosphorotriamide, and sulfolane.

The carbon nanotube dispersion of the present invention may further contain an additive depending on the application. Examples of the additive include a thickener, an anti-settling agent, a wetting agent, an emulsifier, an anti-dripping agent, an antifoaming agent, a leveling agent, a plasticizer, an anti-fungal/anti-algal agent, and an antibacterial agent.

The carbon nanotube dispersion of the present invention can be prepared by subjecting the above components to a dispersing treatment using a known dispersing apparatus.

As the dispersing apparatus, a dispersing machine commonly used for pigment dispersion or the like can be used, and examples of the dispersing machine include mixers such as a disperser, a homomixer, a planetary centrifugal mixer, a Henschel mixer, and a planetary mixer, as well as a (high-pressure) homogenizer, a paint conditioner, a colloid mill, dispersing machines using media such as a bead mill, a cone mill, a ball mill, a sand mill, an attritor, a pearl mill, and a co-ball mill, media-less dispersing machines such as a wet jet mill and a thin-film rotary high-speed mixer, and other roll mills.

### Electrode-Forming Composition

The carbon filler dispersant of the present invention can improve dispersibility of a carbon filler used as a conductive material, and therefore can maintain the function of the carbon filler as the conductive material even when the usage amount of the carbon filler is reduced. Therefore, an electrode-forming composition containing the carbon filler dispersant of the present invention can increase a usage amount of an electrode active material, and thus such an electrode-forming composition can enhance the battery performance of the obtained battery.

The content of the carbon filler dispersant in the electrode-forming composition of the present invention is not particularly limited, but the content of the carbon filler dispersant of the present invention is, for example, in a range from 0.01 to 50 parts by mass per 100 parts by mass of the carbon filler, preferably in a range from 0.1 to 40 parts by mass per 100 parts by mass of the carbon filler, and more preferably in a range from 1 to 30 parts by mass per 100 parts by mass of the carbon filler.

Hereinafter, each of the components contained in the electrode-forming composition of the present invention will be described.

### Carbon Filler

The carbon filler contained in the electrode-forming composition of the present invention is the same as the carbon filler contained in the carbon filler-containing dispersion described above.

The content of the carbon filler is not particularly limited, but is, for example, from 0.1 to 30 parts by mass, preferably from 0.1 to 20 parts by mass, more preferably from 1 to 20 parts by mass, and still more preferably from 1 to 15 parts by mass, per 100 parts by mass of the electrode active material.

### Electrode Active Material

The electrode active material is classified into a positive electrode active material used for a positive electrode and a negative electrode active material used for a negative electrode, based on the electromotive force of the respective materials.

Examples of the positive electrode active material include lithium-containing composite oxides, lithium-containing oxides, transition metal oxides, transition metal sulfides, and conductive polymers.

Examples of the lithium-containing composite oxides for use as the positive electrode active material include composite oxides of lithium and one or more selected from the group consisting of Co, Mn, Fe, Cu, Ti, Mg, Ca, Al, W, Mo, Nb, Zn, Sn, Zr, Ga, V, B, and Si.

Specific examples of the lithium-containing composite oxides include LiNi_{0.33}Co_{0.33} Mn_{0.33}O₂, LiNi_{0.5}Co_{0.3}Mn_{0.2}O₂, LiNi_{0.5}Co_{0.2}Mn_{0.3}O₂, LiNi_{0.6}Co_{0.2}Mn_{0.2}O₂, LiNi_{0.8}Co_{0.1} Mn_{0.1}O₂, and LiNi_{0.8}Co_{0.15}Al_{0.05}O₂.

Examples of the lithium-containing oxides for use as the positive electrode active material include lithium-containing oxides such as LiNiO₂, LiCoO₂, LiMnO₂, LiMn₂O₄, and LiNiO₂, and lithium-containing phosphate compounds such as LiFePO₄ and LiMnPO₄.

Examples of the transition metal oxides for use as the positive electrode active material include MnO₂ and V₂O₅.

Examples of the transition metal sulfides for use as the positive electrode active material include MoS₂ and TiS₂.

Examples of the conductive polymer for use as the positive electrode active material include polyaniline, polythiophene, polypyrrole, polyacetylene, polyacene, dimercaptothiadiazole, and polyaniline composite.

A single type of the positive electrode active material may be used alone, or two or more types of the positive electrode active material may be used in combination.

Examples of the negative electrode active material include carbon materials, chalcogen compounds (for example, oxides and sulfides), nitrides, metals, and alloys, and a material that enables doping and de-doping of lithium ions at an electric potential lower than that of the positive electrode can be used.

Examples of the carbon materials that can be used as the negative electrode active material include graphite such as natural graphite and artificial graphite, cokes, carbon black, carbon fibers, and a fired body of an organic polymer compound.

Examples of the oxides that can be used as the negative electrode active material include silicon oxides represented by the formula SiOx (where x is a positive real number), such as SiO₂ and SiO; tin oxides represented by the formula SnOx (where x is a positive real number), such as SnO₂ and SnO; and metal composite oxides containing lithium and titanium, such as Li₄Ti₅O₁₂ and LiVO₂.

Examples of the metals or alloys serving as the negative electrode active material include elemental metals such as lithium metal, silicon metal, and tin metal, and alloys containing these metals.

Among the negative electrode active material, a carbon material containing graphite such as natural graphite or artificial graphite as a main component is preferably used. Reasons for this include that the electric potential of the negative electrode hardly changes from an uncharged state to a fully charged state during charging (good electric potential flatness), and that the average discharge potential is low, and the capacity retention rate after repeated charging and discharging is high (good cycle characteristics). The shape of the carbon material may be, for example, any of a flake shape like that of natural graphite, a spherical shape like that of mesocarbon microbeads, a fibrous shape like that of graphitized carbon fibers, or an aggregate of fine powder.

A single type of negative electrode active material may be used alone, or two or more types of the negative electrode active material may be used in combination.

### Binder Resin

The electrode-forming composition may contain a binder resin, and as the binder resin, a thermoplastic resin can be used.
Specific examples of the thermoplastic resin include polyimide resins; fluororesins such as polyvinylidene fluoride and polytetrafluoroethylene; polyolefin resins such as polyethylene and polypropylene; carboxymethylene cellulose; and styrene-butadiene rubber.

### Electrode for Lithium Secondary Battery

The electrode-forming composition of the present invention is applied onto a current collector and dried, and thus, an electrode for a lithium secondary battery can be formed.
The material and the shape of the current collector are not particularly limited, and examples of the material of the current collector include metals such as aluminum, copper, nickel, titanium, and stainless steel, and alloys thereof. In terms of the shape, a flat foil is generally used, but a current collector having a roughened surface, a current collector in the form of perforated foil, or a current collector in a mesh form may also be used.

The method for applying the electrode-forming composition onto the current collector is not particularly limited, and a known method can be used. Specific examples of the known method include die coating, dip coating, roll coating, doctor coating, knife coating, spray coating, gravure coating, screen printing, and electrostatic coating. Moreover, the drying method is not particularly limited, but standing and drying, a blowing dryer, a hot air dryer, an infrared heater, a far infrared heater, and the like can be used.

### Lithium Secondary Battery

The lithium secondary battery of the present invention is a battery provided with the lithium secondary battery electrode of the present invention, and is preferably a battery provided with the electrode for a lithium secondary battery of the present invention as a positive electrode.

The lithium secondary battery of the present invention may be any lithium secondary battery in which at least one electrode contains a carbon filler and the carbon filler dispersant of the present invention, and the form of the lithium secondary battery of the present invention may be any of a lithium-ion secondary battery in which the electrolyte is a liquid and a separator is included, an all-solid secondary battery in which the electrolyte is a solid, or a semi-solid secondary battery in which the electrolyte is present both as a solid and as a liquid.

### EXAMPLES

The present invention will be specifically described with reference to Examples and Comparative Examples below.

Note that the present invention is not limited to the following Examples.

In Examples of the present application, the acid value and the hydroxyl value are values that are evaluated by the following methods.

### Method for Measuring Acid Value

The acid value was measured by a method in accordance with JIS K 0070-1992.

### Method for Measuring Hydroxyl Value

The hydroxyl value was measured by a method in accordance with JIS K 0070-1992.

In Examples of the present application, the number-average molecular weight of the polyester is a value in terms of calibration with a polystyrene standard based on GPC measurements, and the measurement conditions were as follows.

### GPC Measurement Conditions

Measuring instrument: high performance GPC system “HLC-8320GPC” available from Tosoh Corporation
Columns: “TSK GUARD COLUMN SuperHZ-L” available from Tosoh Corporation+ “TSK gel SuperHZM-M” available from Tosoh Corporation+ “TSK Gel SuperHZM-M” available from Tosoh Corporation+ “TSK Gel SuperHZ-2000” available from Tosoh Corporation+ “TSK Gel SuperHZ-2000” available from Tosoh Corporation
Detector: RI (differential refractometer)
Data processing: “EcoSEC Data Analysis Version 1.07” available from Tosoh Corporation
Column temperature: 40° C.
Developing solvent: tetrahydrofuran
Flow rate: 0.35 mL/min
Measurement sample: 7.5 mg of a sample was dissolved in 10 ml of tetrahydrofuran, the resultant solution was filtered through a microfilter, and the obtained product was used as a measurement sample.
Sample injection volume: 20 μL
Standard sample: The following monodisperse polystyrenes having known molecular weights were used in accordance with the measurement manual of “HLC-8320GPC”.

### Monodisperse Polystyrene

“A-300” available from Tosoh Corporation
“A-500” available from Tosoh Corporation
“A-1000” available from Tosoh Corporation
“A-2500” available from Tosoh Corporation
“A-5000” available from Tosoh Corporation
“F-1” available from Tosoh Corporation
“F-2” available from Tosoh Corporation
“F-4” available from Tosoh Corporation
“F-10” available from Tosoh Corporation
“F-20” available from Tosoh Corporation
“F-40” available from Tosoh Corporation
“F-80” available from Tosoh Corporation
“F-128” available from Tosoh Corporation
“F-288” available from Tosoh Corporation

Whether the polyester was crystalline or amorphous was confirmed by carrying out differential scanning calorimetry under the following conditions. Specifically, in the following second temperature increase, a sample having a distinct endothermic peak indicating melting of crystalline components was determined to be crystalline, and a sample having no endothermic peak was determined to be amorphous.

### Differential Scanning Calorimetry Conditions

Measuring instrument: DSC3+ available from Mettler-Toledo GmbH
Data processing: STARe Software
Measurement conditions: (1) increase temperature from 25° C. to 300° C. (10° C./min): first temperature increase
(2) decrease the temperature from 300° C. to 25° C. (10° C./min): cooling
(3) hold the temperature at 25° C. for 5 minutes
(4) increase the temperature from 25° C. to 300° C. (10° C./min): second temperature increase

### Synthesis Example 1: Synthesis of Dispersant A

A four-necked flask having an internal volume of 3 L and equipped with a thermometer, a stirrer, and a reflux condenser was charged with 476 g of propylene glycol as a glycol component, 554 g of dimethyl terephthalate as a dicarboxylic acid component, 817 g of para-toluic acid as a monocarboxylic acid component, and 0.11 g of tetra-isopropyl titanate as a catalyst, and the resultant mixture was heated stepwise to 230° C. over 5 hours while being stirred under a nitrogen gas stream, and when the temperature reached 230° C., a condensation reaction was carried out for 12 hours. After the reaction, an unreacted raw material and a low-volatile component were removed under reduced pressure at 195° C., and thus, a dispersant A was obtained as a polyester.

The obtained dispersant A was a viscous liquid at room temperature, and had an acid value of 0.19 mgKOH/g, a hydroxyl value of 11 mgKOH/g, and a number-average molecular weight of 450. In addition, no distinct endothermic peak was obtained in differential scanning calorimetry, and thus it was confirmed that the dispersant A was an amorphous polyester.

### Synthesis Example 2: Synthesis of Dispersant B

A stainless steel flask having an internal volume of 0.3 L and equipped with a thermometer, a stirrer, and a reflux condenser was charged with 129 g of dimethyl 2,6-naphthalenedicarboxylate and 95 g of terephthalic acid as dicarboxylic acid components, 98 g of propylene glycol and 9 g of ethylene glycol as glycol components, and 0.01 g of tetra-isopropyl titanate as a catalyst, and the resultant mixture was heated stepwise to 200° C. over 2 hours while being stirred under a nitrogen gas stream, and when the temperature reached 200° C., a condensation reaction was carried out for 40 hours. After the reaction, an unreacted raw material and a low-volatile component were removed under reduced pressure at 160° C., and thus, a dispersant B was obtained as a polyester.

The obtained dispersant B was solid at room temperature, and had an acid value of 0.60 mgKOH/g, a hydroxyl value of 109 mgKOH/g, and a number-average molecular weight of 1400. In addition, no distinct endothermic peak was obtained in differential scanning calorimetry, and thus it was confirmed that the dispersant B was an amorphous polyester.

### Synthesis Example 3: Synthesis of Dispersant C

A four-necked flask having an internal volume of 3 L and equipped with a thermometer, a stirrer, and a reflux condenser was charged with 512 g of propylene glycol as a glycol component, 971 g of dimethyl terephthalate as a dicarboxylic acid component, and 0.08 g of tetra-isopropyl titanate as a catalyst, and the resultant mixture was heated stepwise to 220° C. over 5 hours while being stirred under a nitrogen gas stream, and when the temperature reached 220° C., a condensation reaction was carried out for 6 hours. After the reaction, the reaction mixture was further subjected to a condensation reaction at 220° C. under reduced pressure for 2 hours, an unreacted raw material and a low-volatile component were removed, and thus, a dispersant C was obtained as a polyester.

The obtained dispersant C was solid at room temperature, and had an acid value of 1.1 mgKOH/g, a hydroxyl value of 67 mgKOH/g, and a number-average molecular weight of 1500. In addition, no distinct endothermic peak was obtained in differential scanning calorimetry, and thus it was confirmed that the dispersant C was an amorphous polyester.

### Synthesis Example 4: Synthesis of Dispersant D

A four-necked flask having an internal volume of 3 L and equipped with a thermometer, a stirrer, and a reflux condenser was charged with 409 g of ethylene glycol as a glycol component, 741 g of phthalic anhydride as a dicarboxylic acid component, and 0.07 g of tetra-isopropyl titanate as a catalyst, and the resultant mixture was heated stepwise to 220° C. over 5 hours while being stirred under a nitrogen gas stream, and when the temperature reached 220° C., a condensation reaction was carried out for 6 hours. After the reaction, the reaction mixture was further subjected to a condensation reaction at 220° C. under reduced pressure for 2 hours, an unreacted raw material and a low-volatile component were removed, and thus, a dispersant D was obtained as a polyester.

The obtained dispersant D was solid at room temperature, and had an acid value of 0.26 mgKOH/g, a hydroxyl value of 35 mgKOH/g, and a number-average molecular weight of 1670. In addition, no distinct endothermic peak was obtained in differential scanning calorimetry, and thus it was confirmed that the dispersant D was an amorphous polyester.

### Synthesis Example 5: Synthesis of Dispersant E

A four-necked flask having an internal volume of 1 L and equipped with a thermometer, a stirrer, and a reflux condenser was charged with 307 g of propylene glycol as a glycol component, 498 g of isophthalic acid as a dicarboxylic acid component, and 0.05 g of tetra-isopropyl titanate as a catalyst, and the resultant mixture was heated stepwise to 230° C. over 10 hours while being stirred under a nitrogen gas stream, and when the temperature reached 230° C., a condensation reaction was carried out for 7 hours. After the reaction, the reaction mixture was further subjected to a condensation reaction at 230° C. under reduced pressure for 3 hours, an unreacted raw material and a low-volatile component were removed, and thus, a dispersant E was obtained as a polyester.

The obtained dispersant E was solid at room temperature, and had an acid value of 0.89 mgKOH/g, a hydroxyl value of 70 mgKOH/g, and a number-average molecular weight of 1920. In addition, no distinct endothermic peak was obtained in differential scanning calorimetry, and thus it was confirmed that the dispersant E was an amorphous polyester.

### Synthesis Example 6: Synthesis of Dispersant F

A four-necked flask having an internal volume of 2 L and equipped with a thermometer, a stirrer, and a reflux condenser was charged with 486 g of propylene glycol and 21 g of ethylene glycol as glycol components, 831 g of terephthalic acid as a dicarboxylic acid component, and 0.08 g of tetra-isopropyl titanate as a catalyst, and the resultant mixture was heated stepwise to 235° C. over 64 hours while being stirred under a nitrogen gas stream, and when the temperature reached 230° C., a condensation reaction was carried out for 8 hours. After the reaction, the reaction mixture was further subjected to a condensation reaction at 235° C. under reduced pressure for 2 hours, an unreacted raw material and a low-volatile component were removed, and thus, a dispersant F was obtained as a polyester.

The obtained dispersant F was solid at room temperature, and had an acid value of 1.05 mgKOH/g, a hydroxyl value of 42 mgKOH/g, and a number-average molecular weight of 3690. In addition, no distinct endothermic peak was obtained in differential scanning calorimetry, and thus it was confirmed that the dispersant F was an amorphous polyester.

### Synthesis Example 7: Synthesis of Dispersant G

A four-necked flask having an internal volume of 2 L and equipped with a thermometer, a stirrer, and a reflux condenser was charged with 361 g of 2-methyl-1,3-propanediol as a glycol component, 498 g of terephthalic acid as a dicarboxylic acid component, and 0.05 g of tetra-isopropyl titanate as a catalyst, and the resultant mixture was heated stepwise to 225° C. over 26 hours while being stirred under a nitrogen gas stream, and when the temperature reached 225° C., a condensation reaction was carried out for 2 hours. After the reaction, the reaction mixture was further subjected to a condensation reaction at 225° C. under reduced pressure for 4 hours, an unreacted raw material and a low-volatile component were removed, and thus, a dispersant G was obtained as a polyester.

The obtained dispersant G was solid at room temperature, and had an acid value of 0.82 mgKOH/g, a hydroxyl value of 36 mgKOH/g, and a number-average molecular weight of 7930. In addition, no distinct endothermic peak was obtained in differential scanning calorimetry, and thus it was confirmed that the dispersant G was an amorphous polyester.

### Synthesis Example 8: Synthesis of Dispersant H

A four-necked flask having an internal volume of 3 L and equipped with a thermometer, a stirrer, and a reflux condenser was charged with 347 g of neopentyl glycol as a glycol component, 415 g of terephthalic acid as a dicarboxylic acid component, and 0.05 g of tetra-isopropyl titanate as a catalyst, and the resultant mixture was heated stepwise to 230° C. over 33 hours while being stirred under a nitrogen gas stream, and when the temperature reached 230° C., a condensation reaction was carried out for 8 hours. After the reaction, the reaction mixture was further subjected to a condensation reaction at 230° C. under reduced pressure for 1 hour, an unreacted raw material and a low-volatile component were removed, and thus, a dispersant H was obtained as a polyester.

The obtained dispersant H was solid at room temperature, and had an acid value of 0.95 mgKOH/g, a hydroxyl value of 71 mgKOH/g, and a number-average molecular weight of 2100. In addition, no distinct endothermic peak was obtained in differential scanning calorimetry, and thus it was confirmed that the dispersant H was an amorphous polyester.

### Synthesis Example 9: Synthesis of Dispersant I

A four-necked flask having an internal volume of 3 L and equipped with a thermometer, a stirrer, and a reflux condenser was charged with 325 g of propylene glycol as a glycol component, 733 g of dimethyl 2,6-naphthalenedicarboxylate as a dicarboxylic acid component, and 0.06 g of tetra-isopropyl titanate as a catalyst, and the resultant mixture was heated stepwise to 220° C. over 25 hours while being stirred under a nitrogen gas stream, and when the temperature reached 220° C., a condensation reaction was carried out for 36 hours. After the reaction, the reaction mixture was further subjected to a condensation reaction at 220° C. under reduced pressure for 2 hours, an unreacted raw material and a low-volatile component were removed, and thus, a dispersant I was obtained as a polyester.

The obtained dispersant I was solid at room temperature, and had an acid value of 0.74 mgKOH/g, a hydroxyl value of 85 mgKOH/g, and a number-average molecular weight of 1810. In addition, no distinct endothermic peak was obtained in differential scanning calorimetry, and thus it was confirmed that the dispersant I was an amorphous polyester.

### Comparative Synthesis Example 1: Synthesis of Dispersant A′

A four-necked flask having an internal volume of 2 L and equipped with a thermometer, a stirrer, and a reflux condenser was charged with 2456 g of adipic acid as a dicarboxylic acid component, 676 g of 1,4-butanediol and 782 g of neopentyl glycol as glycol components, 260 g of isononyl alcohol as a monohydric alcohol component, and 0.13 g of tetra-isopropyl titanate as a catalyst, and the resultant mixture was heated stepwise to 220° C. over 5 hours while being stirred under a nitrogen gas stream, and when the temperature reached 220° C., a condensation reaction was carried out for 19 hours. After the reaction, an unreacted raw material and a low-volatile component were removed under reduced pressure at 200° C., and a dispersant A′ was obtained as a polyester.
The obtained dispersant A′ was solid at room temperature, and had an acid value of 34 mgKOH/g, a hydroxyl value of 1 mgKOH/g, and a number-average molecular weight of 1400.

### Examples 1 to 6 and Comparative Examples 1 to 3: Preparation and Evaluation of Carbon Filler-Containing Compositions

For each of Examples 1 to 6 and Comparative Examples 1 to 3, Ketjenblack (“EC300J” available from Lion Specialty Chemicals Co., Ltd., primary particle size: 39.5 nm) as a carbon filler, N-methylpyrrolidone (NMP) as a solvent, a dispersant described in Table 1, and glass beads (φ0.1 mm) as a dispersion medium were charged into a 100 mL plastic bottle at the amounts described in Table 1, respectively. The plastic bottle was set in a paint shaker (available from Toyo Seiki Seisaku-sho, Ltd.), and the mixture in the plastic bottle was subjected to a dispersion treatment at room temperature for 30 minutes at a speed of 750 cpm.
The dispersion treated mixture was passed through a 300 mesh wire mesh to filter out the glass beads, and a carbon dispersion liquid was obtained.

The particle size distribution of the Ketjenblack in the obtained carbon dispersion liquid was evaluated by histogram analysis using a dynamic light scattering particle size distribution analyzer (“ELSZ-2000”, available from Otsuka Electronics Co., Ltd.). The D10, D50, and D90 obtained through the histogram analysis are shown in Table 1.

TABLE 1

| | | | | | | | | Comparative | Comparative | Comparative |
|---|---|---|---|---|---|---|---|---|---|---|
| | | Example 1 | Example 2 | Example 3 | Example 4 | Example 5 | Example 6 | Example 1 | Example 2 | Example 3 |
| Dispersant | | Dispersant | Dispersant | Dispersant | Dispersant | Dispersant | Dispersant | BLANK | Dispersant | Dispersant |
| | | A | B | C | D | E | F | | A′ | B′ |
| Mixture | Dispersant | 1 | 1 | 1 | 1 | 1 | 1 | | 1 | 1 |
| Composition | Ketjenblack | 5 | 5 | 5 | 5 | 5 | 5 | 5 | 5 | 5 |
| (parts by | NMP | 95 | 95 | 95 | 95 | 95 | 95 | 95 | 95 | 95 |
| mass) | Glass beads | 25 | 25 | 25 | 25 | 25 | 25 | 25 | 25 | 25 |
| Particle Size | D10 | 362 | 130 | 114 | 191 | 109 | 111 | 457 | 335 | 222 |
| Distribution | D50 | 621 | 270 | 261 | 790 | 386 | 269 | 529 | 476 | 530 |
| [nm] | D90 | 5735 | 486 | 709 | 1919 | 1372 | 496 | 10583 | 12261 | 9008 |

In Table 1, the dispersant B′ of Comparative Example 3 was hydrogenated nitrile rubber (“Therban 3446” available from ARLANXEO Holding B.V.) known as a dispersant.

As is clear from the results in Table 1, it can be confirmed that aggregation of the Ketjenblack was effectively suppressed by using the dispersants of Synthesis Examples. On the other hand, with the dispersants A′ and B′ of the comparative examples, the D90 particle size increased significantly, and it can be confirmed that coarse aggregates were formed.

### Examples 7 to 10 and Comparative Examples 4 and 5: Preparation and Evaluation of Carbon Filler-Containing Compositions

For each of Examples 7 to 10 and Comparative Examples 4 and 5, a carbon dispersion liquid was prepared in the same manner as that in Examples 1 to 6 and Comparative Examples 1 to 3 with the exception that multi-walled carbon nanotubes (“K-Nanos 300T” available from Kumho Petrochemical, Co., diameter: 10 to 15 nm, length: 60 to 90 μm) were used as the carbon filler and the dispersion treatment was carried out for 120 minutes. The particle size distribution of the multi-walled carbon nanotubes in the carbon dispersion liquid was evaluated. The results are presented in Table 2.

TABLE 2

| | | | | | | Comparative | Comparative |
|---|---|---|---|---|---|---|---|
| | | Example 7 | Example 8 | Example 9 | Example 10 | Example 4 | Example 5 |
| Dispersant | | Dispersant | Dispersant | Dispersant | Dispersant | BLANK | Dispersant B′ |
| | | F | G | H | I | | |
| Mixture | Dispersant | 0.5 | 0.5 | 0.5 | 0.5 | | 0.5 |
| Composition | Multi-walled | 2.5 | 2.5 | 2.5 | 2.5 | 2.5 | 2.5 |
| (parts by | carbon nanotubes | | | | | | |
| mass) | NMP | 97.5 | 97.5 | 97.5 | 97.5 | 97.5 | 97.5 |
| | Glass beads | 100 | 100 | 100 | 100 | 100 | 100 |
| Particle Size | D10 | 106 | 80 | 63 | 101 | 98 | 147 |
| Distribution | D50 | 164 | 178 | 154 | 174 | 21919 | 227 |
| [nm] | D90 | 325 | 2521 | 5608 | 3110 | 33968 | 8389 |

As is clear from the results in Table 2, it can be confirmed that aggregation of the multi-walled carbon nanotubes is effectively suppressed by using the dispersants of Synthesis Examples, respectively.

1. A carbon filler dispersant that is a polyester represented by General Formula (1-1), (1-2), or (1-3): 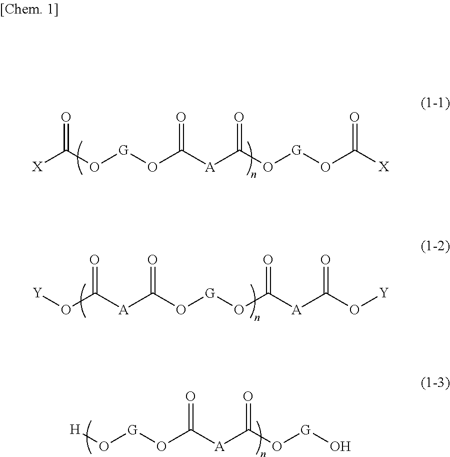
(In General Formulae (1-1), (1-2), and (1-3),
G is an aliphatic diol residue having from 2 to 20 carbons,
A is an aromatic dicarboxylic acid residue having from 4 to 18 carbons,
X is a monocarboxylic acid residue having from 1 to 20 carbons,
Y is a monohydric alcohol residue having from 1 to 30 carbons, and
n represents the number of repetitions.)

2. The carbon filler dispersant according to claim 1, wherein A comprises one or more selected from a phthalic acid residue, an isophthalic acid residue, a terephthalic acid residue, and a naphthalenedicarboxylic acid residue.

3. The carbon filler dispersant according to claim 1, wherein G is an aliphatic diol residue having a branched structure having 3 to 20 carbons.

4. The carbon filler dispersant according to claim 1, wherein the polyester is an amorphous polyester.

5. The carbon filler dispersant according to claim 1, wherein the polyester has a number-average molecular weight in a range from 400 to 10000.

6. The carbon filler dispersant according to claim 1, wherein the carbon filler is one or more selected from graphite, carbon black, carbon nanotubes, graphene, and graphene oxide.

7. A carbon filler dispersion comprising a carbon filler, the carbon filler dispersant described in claim 1, and a dispersion medium.

8. The carbon filler dispersion according to claim 7, wherein the carbon filler is one or more selected from graphite, carbon black, carbon nanotubes, graphene, and graphene oxide.

9. An electrode for a lithium secondary battery, the electrode comprising a carbon filler, the carbon filler dispersant described in claim 1, and an electrode active material.

10. A lithium secondary battery comprising the electrode for a lithium secondary battery described in claim 9.

11. The carbon filler dispersant according to claim 2, wherein G is an aliphatic diol residue having a branched structure having 3 to 20 carbons.

12. The carbon filler dispersant according to claim 2, wherein the polyester is an amorphous polyester.

13. The carbon filler dispersant according to claim 2, wherein the polyester has a number-average molecular weight in a range from 400 to 10000.

14. The carbon filler dispersant according to claim 2, wherein the carbon filler is one or more selected from graphite, carbon black, carbon nanotubes, graphene, and graphene oxide.

15. A carbon filler dispersion comprising a carbon filler, the carbon filler dispersant described in claim 2, and a dispersion medium.

16. The carbon filler dispersion according to claim 15, wherein the carbon filler is one or more selected from graphite, carbon black, carbon nanotubes, graphene, and graphene oxide.

17. An electrode for a lithium secondary battery, the electrode comprising a carbon filler, the carbon filler dispersant described in claim 2, and an electrode active material.

18. A lithium secondary battery comprising the electrode for a lithium secondary battery described in claim 17.
